(19) United States
(12) Patent Application Publication
(10) Pub. No.: US 2004/0121913 A1
(43) Pub. Date: Jun. 24, 2004

(54) ''Secondary'' substances found in chitin crustacea shell

(76) Inventor: Donald Ernest Freepons, Pasco, WA (US)

Correspondence Address: Donald E. Freepons, 6016 Candlestick Drive, Pasco, WA, 99301, US

(21) Appl. No.: 10/327,668

(22) Filed: Dec. 23, 2002

(51) Int. Cl. A01N 43/04; A01N 43/16

(52) U.S. Cl. 504/292; 504/358

(57) ABSTRACT

This invention is related to a group of bioactive or secondary plant growth regulating substances that are naturally a part of the chitin molecule of shrimp, crab, lobster shell and the shell of other crustacea.

These secondary substances can produce surprising bioactivity when managed properly to increase food crop yields. Coming from a waste problem of huge proportions, they represent a recycling opportunity at its best.

### CROSS-REFERENCE TO RELATED APPLICATION

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This invention pertains to the biochemistry of chitin, a naturally occurring substance that has shown promising yield enhancements in potatoes, tomatoes, rice and other commercial crops, more particularly a group of biochemicals that are produced and reside on the chitin molecule.

Since the early times, seeds have been treated with chemicals to stave off seed decays and molds, and diseases before germination that affect root development of new seedlings.

Even today with our disease resistant varieties, seeds are suspect to diseases after being planted in cold and wet soils. These diseases, carried on to the newly planted seeds are transported from last year's fields to the soil of the new field where they are to be grown. Growers only hope for close to a 100% stand. As a result of this work, germination has been improved and plant stands were increased.

The principal action of seed coatings is to create a fungicidal barrier on the seed to deter seed decay. They do not improve the yield of a normal crop. Fundamentally, the fungicides “hedge” against reduced yields caused by poor stands.

Environmental conservationists are quick to point out that “treating” the seed is the safest method of disease control because of the ratio of soil to seed. For example, treating the soil for a crop planted between 3 inches and 6 inches deep contaminates about 11,000 cubic feet of soil but only 1 cubic foot of seeds.

Today's seed treatments are methods to reduce yield losses to poor stands and are not a means to increase yields above 100%. Our growers need something that will work in conjunction with these fungicidal barriers.

### BRIEF SUMMARY OF THE INVENTION

Chitin, the “building block” for the shell of all crustacean is the second most abundant natural resource, second only to cellulose, is a waste material from the shellfish industry and has seemingly little use except as a dietary aid for obese people. It was thought to have a role as a seed coating for agriculture but after many unexplained field seed coating failures, that use has been almost abandoned. Every conceivable modification was tried to adapt it for seed coating but to no avail. Field failures persisted.

By pure chance, a change was made in its production that produced excellent yield increases. It was found that treating natural chitin or chitosan with an oxidizer such as chlorine changed the molecule. Bleaching removed a “group of Secondary Substances”. Chlorine was used to deodorize and bleach the chitosan for its role in the dietary market.

Bioactive Secondary Substances when applied to potato seed pieces did not increase yields whereas it was known that the chitosan or chitin from which it was produced did increase potato yields. Leading to the discovery was the fact that chlorine is a harsh chemical and can destroy many of the Secondary Substances normally residing on the chitosan molecule.

During the normal process of “shearing” the acetyl groups from chitin to form chitosan, these substances were not removed or damaged. Substances such as antioxidants, astaxanthin and some of the phenolic compounds. Investigators think these “secondary substances” include terpene compounds, phenolic compounds, including anthocyanins, anthocyadins, mono and polyphenols, and anti-oxidants.

To test our new concept, the CBC/WTC Research 2001 trial (Table #3) showed:

1. Unbleached chitosan that was produced from unbleached chitin and applied as a SEED COATING increased yields significantly over the controls.

2. Unbleached chitosan that was produced from unbleached chitin and applied as a LIQUID IN A PLANTER BAND increased yields significantly.

3. Unbleached chitosan that was produced from unbleached chitin that was applied as an IMPREGNATED GRANULE yielded significantly better yields than the control.

The trial was installed as an integral part of the field. The soil preparation was identical as a part of the field, the planter used was one of seven used for planting, and the cultural practices were consistent with the balance of the field. The independent variable was the application of unbleached chitosan that was produced from unbleached chitin to all treatments.

### BRIEF DESCRIPTION OF THE SEVERAL VIEWS OF THE DRAWING

“Not Applicable”

### DETAILED DESCRIPTION OF THE INVENTION

Chitosan opens a new era of seed coatings, seed coatings that are based on natural biochemistry. Chitosan brings into being biologically active substances that function completely different than conventional fungicide seed coatings. Chitosan is not intended to replace these fungicides but to function in concert with them.

Chitosan seed coatings have caused dramatic yield increases above the normal yields but unfortunately chitosan's performance has been erratic. There have been occasions that showed no yield responses and seemingly for no reason. To understand these failures, consideration was given to all parameters that might conceivably impact chitosan's bioactivity.

For example: it was found that the chitosan solution had a limited or finite shelf life. The percent of deacetylation was important, as was the molecular weight. The acid solubilizer was important, too.

Finally, it has been found that when unbleached chitosan that was produced from unbleached chitin was solublized with glutamic acid, and the solution applied to seeds or tubers, etc., or to the soil where the seeds are to be planted, yields were increased. In the CBC/WTC study, 5+t/acre potato yield increases were documented using these seed treatments under commercial growing conditions.

By comparison, coating seeds with chitosan that was bleached or produced from chitin that was bleached did not increase yields.

Science suggests that there are “Secondary Substances” that reside naturally on the chitin molecule and that normal processing procedures used in producing chitosan do not remove these bioactive natural substances.

Investigators think these ‘Secondary’ Substances include terpene compounds, phenolic compounds including athocyanins, anthocyadins mono and polyphenols, and anti-oxidants, such as astaxanthin.

Why ‘bleach’ the chitin/chitosan? In the rapidly developing chitosan market of the 70's and on, weight reduction became a ‘hot’ chitosan market but what consumer wanted to have an after-taste of shrimp in their stomach. To clean up the chitosan, it was bleached to remove both the odor and the fishy taste.

How important is the chitosan solubilizer? Could the molecular weight of the chitosan be a factor? Could the percent of deacetylation contribute and the application methods. Did the process by which it was produced affect its bioactivity?

There are two types of chitosan commercially available: industrial which has not been bleached and has been derived from unbleached chitin and, bleached chitosan.

Chitosan that has not been treated with an oxidizer contains Secondary Substances. These Secondary Substances include antioxidants such as polyphenols, colorants and catechols that carry biochemical properties. When bleached, these Secondary Substances are destroyed or converted into such compounds as quinoines which do not enhance crop yields.

Early in our work, we produced an increase of 673 lbs. of rice per acre using chitosan treated seed. Potato yields increased to 4+ton/acre. Tomato quality was improved due to an increase in solids.

Chitosans that have been ‘bleached’ show little or no bioactivity. For example:

TABLE #1
Control: (untreated potato seed)

| 1^{st} Load | 3 rows | 29,710 lb | 2171 feet of row | 35.06564 ton/acre |
|---|---|---|---|---|
| 2^{nd} Load | 3 rows | 28,440 lb | 1941 feet of row | 37.54421 tons/acre |
| | | | Average | 36.30493 |

Bleached Chitosan (treated potato seed)

| | | | | |
|---|---|---|---|---|
| 1^{st} load | 6 rows | 28,510 lb | 968 feet of row | 37.73382 ton/acre |
| 2^{nd} load | 6 rows | 29,130 lb | 1061 feet of row | 35.17500 ton/acre |
| | | | Average | 36.45441 |

Chitosan effect: +0.14949 ton/acre 298.98 lb/acre (0.412%)

TABLE #2
By comparison
Control (untreated seed)

| | | | |
|---|---|---|---|
| Average sample weight in lb | N = 12 | 89.9 | 34.4 ton/acre |

Unbleached Chitosan-treated potato seed

| | | | |
|---|---|---|---|
| Average sample weight in lb | N = 12 | 101.6 | 39.1 ton/acre |

Chitosan effect: +4.7 ton/acre (+13.67%)

Placement:

Since the chitosan must enter the plant via the roots two very important requirements are essential. The root must have intimate access or contact with the chitosan and the chitosan must be in solution before the root can absorb it.

Newly developing roots are gravitropically, positive i.e., sensitive to gravity, always growing down into the soil in search of moisture and nutrients.

Secondary ‘feeder’ roots are gravitropically negative thus growing in the soil more or less horizontally. Though the seed is thoroughly coated with chitosan, in reality the only point of contact that the newly developing primary root has with the chitosan seed coating is at the point of emergence. All the chitosan that is applied to the balance of the seed coat is in effect, unavailable to the emerging root.

By comparison, early seedling roots contact the planter-banded chitosan in the soil immediately after emergence and continue during root development. Additionally, chitosan applied to the seed piece is dried to a film, which must take up water before the root, can absorb it. Whereas the planter-banded chitosan is placed in the firm moist undisturbed soil thus never has an opportunity to become a dry film. It is ready to be absorbed.

TABLE #3
CBC/WTC Research 2001.
Average sample weights were measured in lb
and calculated to tons/acre.

| | Chitosan | Chitosan | Planter banded | Planter banded |
|---|---|---|---|---|
| Control | Seed Coated | Seed Coated | Chitosan liquid | Chitosan granule |
| *N = 12 | *N = 5 | *N = 10 | *N = 5 | *N = 5 |
| 89.5 lb | 96.6 lb | 94.5 lb | 105.2 lb | 101.8 lb |
| 34.4 t/a | 37.2 t/a | 36.3 t/a | 40.4 t/a | 39.2 t/a |
| | A¹ = .005 | A¹ = .025 | A¹ = .01 | A¹ = .025 |

*N = number of samples
¹Sadler's A-Statistical test for significance using correlated samples.

From a 5× replicated, random, paired sample, linear experimental design, it was documented that

if: the chitosan is unbleached and produced from unbleached chitin.

then chitosan seed treatments produced dependable yield increases of potatoes.

From the data in Table #3:

Chitosan seed coatings increased the yield of potatoes 9.5% more than the Control, an increase of 3.3 t/a.

Chitosan impregnated granules increased the yield 12.6% more than the Control, an increase of 4.5 t/a.

Chitosan Liquid planter banding increased the yield 16.8% more than the Control an increase of 6.0 t/a.

These data suggest that when the chitosan solution is sprayed onto the seed piece, the emerging roots have restricted access to the chitosan. The data also show that when the chitosan solution is placed in the bottom of the furrow with the seeds placed directly onto this ‘band’, the emerging roots have ample access to the chitosan-rich band. Therefore, it is concluded that a planter banded chitosan application is a more effective method for applying the chitosan solution. Additionally, applying a planter-band is less complicated and metering is absolute as compared to a spray application to the seed pieces.

Now with a controlled procedure to treat the potato seed and a chitosan seed treatment that is assured to be bioactive, we look for continued yield increases of 2 tons up for our growers.

I claim:

1.) A unique group of biochemicals that are produced by crustacea and reside on the chitin molecule, that when applied to seeds and tubers, the soil in which the seeds and tubers are planted and to the foliage of the developing plant and:
a) Increase root bulk.
b) Increase yields.
c) That when separated from the chitosan molecule can be blended with other growth promoters.
d) That when separated from the chitosan molecule can be used for long term seed treatment.

2.) claim 1 wherein these biochemicals include but are not limited to terpene compounds, phenolic compounds including anthocyanins, anthocyadins mono and polyphenols, anti-oxidants, astaxanthin, catchcols, hydroquinones, procyanidins, and lipoproteins.

3.) claims 1 and 2 wherein the Secondary Substances are processed into an acceptable form for the plant to absorb.
